(19) United States
(12) Patent Application Publication
(10) Pub. No.: US 2025/0349479 A1
(43) Pub. Date: Nov. 13, 2025

(54) Switching Device Using Split Movable Carrier Set With Incorporated Main And Auxiliary Electrical Conductors

(71) Applicant: WEG Drives & Controls - Automação Ltda., Jaraguá do Sul (BR)

(72) Inventors: Andre Albuquerque, Jaraguá do Sul (BR); Deivt Tomaselli, Jaraguá do Sul (BR); Juliano Rosso, Jaraguá do Sul (BR)

(21) Appl. No.: 18/552,175

(22) PCT Filed: Mar. 26, 2021
(86) PCT No.: PCT/BR2021/050127

§ 371 Date: Mar. 11, 2024

(51) Int. Cl. H01H 50/04; H01H 50/54

(52) U.S. Cl. CPC H01H 50/045; H01H 50/546

(57) ABSTRACT

A switching device including at least one pair of main fixed elongated conductor members arranged on a lower set wherein each of the main fixed elongated conductor members include a main fixed conductor end, wherein the main fixed conductor ends of the pair of main fixed elongated conductor members are separated from each other by a gap. A stationary intermediate set includes a fixed core and a coil, arranged above the lower set. An upper cover is arranged above the stationary intermediate set. A split movable carrier includes an upper portion, arranged above the fixed core and a lower portion arranged below the fixed core, which houses at least one main movable conductor bridge including main movable conductor ends. The upper portion of the split movable carrier houses a movable core and at least one auxiliary movable conductor bridge including auxiliary conductor ends and wherein the lower portion houses at least one main movable conductor bridge.

### TECHNICAL FIELD

The present invention is part of the electrical technical field, relating specifically to an electromagnetic switching device, known as contactor. This switching device has an electromagnetic actuation system, comprised by a coil and one movable and fixed cores, wherein the main power conductors are positioned at the base of the device, below the electromagnetic actuation system and one or more auxiliary and command conductors, which are incorporated to the enclosure, positioned on the upper part of the switching device.

### BACKGROUND OF THE INVENTION

There are currently at least two main assembly concepts known for facilitating replacing the command coil in switching devices. In a first known concept, the coil is located below and in a second concept, the coil is located above the main power conductors of the switching devices.

In the first concept cited above, the main, auxiliary and command conductors are positioned on the upper part, prioritizing the assembly access and replacement of the coil through the lower part of the device, and wherein the access for assembly and disassembly of the main and auxiliary conductors is performed through a set of intermediate, generally split enclosures. This occurs for switching devices with auxiliary conductors incorporated into the enclosure. This model of the state of the art shows difficulties in the assembly of the final set, due to alignment mounting details of the main and auxiliary conductors, which do not have a facilitated access for inspection or subsequent maintenance. This arrangement wherein the main conductors are positioned in an intermediate split set of the devices, nowadays are commonly covered with an additional layer for closing of the split intermediate enclosure sets. Added to these characteristics, the use of split enclosures can impair the robustness of the set, when these devices are submitted to great mechanical operating efforts, such as a short-circuit, for example.

In these configurations containing split intermediate enclosures, wherein the positioning of the coil is provided in the lower set of the switching device and the positioning of the main conductors is made in the intermediate position above the coil, there is the need for a connection between the coil power conductors, arranged on the upper part of the device and the coil arranged on the lower part, since the lower set must enable the connection thereof in the assembly and disassembly when it is disconnected for maintenance. This electric connection between the upper part, the intermediate and the lower (wherein the coil is located) is usually made by a spring or by a similar pressure terminal system, allowing the occurrence of reliability problems in this connection. There are known failures in the spring or pressure connections, commonly used in industrial assembly processes, whether due to dimensional variation, whether constructive connection technique, which can increase the temperature at specific points in the conductor terminals, whether due to wear or oxidation, reducing the life of the components of the switching device.

The use of the split enclosures demand a reasonable time and many operations, both in manufacturing assembly as in maintenance. In the field of application, it is desired that the final user has access to the change of coils or electrical conductor sets, so as to minimize assembly errors and avoid less specialized work force. For the user or technical assistant to replace the main electrical conductors in the first concept, it is necessary to dismount the split enclosures, which makes this operation difficult outside of an industrial or specialized location. The main and auxiliary movable bridges, housed in a movable carrier must be positioned laterally parallel to the respective fixed conductors, which are inserted on each side of the intermediate split internal enclosures, whereby it is necessary that the three parts (left side, right side and movable carrier between them) be arranged in the correct manner for a successfully assembly. This must be done without the occurrence of a collision between the fixed and movable conductors, which makes the process complex and subject to errors in the operation, if some component is not correctly aligned and positioned.

In an assembly variation, similar to the first concept presented above, the switching device comprises a coil, movable armature and fixed armature on the lower part, an intermediate internal one-piece enclosure as alternative, which contemplates integrated chambers for accommodating the auxiliary fixed and coil command conductors, comprising main, auxiliary conductors, coil command power conductors above the coil and a closing cover, in the search for solving the problems caused and already reported by the use of the internal split enclosures. In this concept, many additional assembly components, such as additional conductor insulating elements are necessary to complete the electric insulation of the switching device.

In the second known assembly concept, the command coil of a switching device is provided on the upper part, which allows a facilitated access to the main conductors, positioned next to the base of the device, both during assembly as during maintenance. In an alternative manner, by means of a “split movable carrier”, there are accommodated on the lower part of the device the main movable power bridges, and on the upper part, the coil, movable and fixed core. The coil positioned on the upper part of the device is dimensioned to act in the opening and closing of the movable core. This solution was conceived in the state of the art for products wherein the replacement of the main electrical conductors is economically advantageous, and in cases wherein the mechanical life of the switching device is greater than the electrical life, for example, from six to 12× greater.

### STATE OF THE ART

In a first assembly concept as cited above, the document EP1051718 of the state of the art presents a switching device comprising coil, movable and fixed armature on the lower part, split intermediate enclosures comprising the main, auxiliary and command conductors, above the coil and a closing cover.

In yet another example of the first assembly concept, a switching device in this configuration can be seen in document WO201482144, also comprising coil, movable and fixed armature on the lower part, split intermediate enclosure main, auxiliary and command conductors above the coil and a closing cover.

Another variation example of the first assembly concept presented above is presented in document EP2135272 of the state of the art, comprising a coil, movable armature and fixed armature on the lower part, an intermediate one-piece internal enclosure, contemplating integrated chambers for accommodating the auxiliary fixed and coil command conductors, comprising main conductors, auxiliary and command power terminals designed above the coil, as well as a closing cover.

In this variation of the first concept there was presented a solution which solved the problem of split enclosures of the first concept, creating a one-piece enclosure, but maintaining the positioning of the coil on the lower part, requiring the use of bridge connections between the coil on the lower part and the coil power terminals, with power access desirably positioned on the upper part for access by the user. Furthermore, additional components are required as insulators, between the auxiliary conductor chambers and the chambers of the main conductors to guarantee a minimal insulation distance (standardized) during the switching processes, and other additional insulating covers on the upper part.

In these configurations of intermediate split enclosures there exists the need to guarantee a good pressure between the connection of the coil command power conductors, positioned on the upper part, above the main conductors, and the coil connection conductors on the lower part of the device.

Yet another similar sample of the first assembly concept is shown in document U.S. Pat. No. 3,639,866. The device comprises a split enclosure for the main conductors, a switching device comprising the main conductors on the lower part, coil, movable and fixed armature on the upper part of the device, as well as a block of auxiliary conductors assembled on the upper part. In this concept, in a disadvantageous manner, however, the split portion extends to the outer portion of the enclosure, allowing flaws in the electrical insulation. Additionally, coil terminals are not offered on the upper part of the switching device, provided to the user, one level below the auxiliary connection terminals.

Document U.S. Pat. No. 4,100,517 refers to an electromagnetic contactor which uses the second main concept cited above, containing the coil on the upper part of the switching device. The device comprises a support base for fixed contacts; movable electric conductors associated with the fixed conductors, a box-shaped enclosure mounted on a base; an electromagnet coil inserted in the box-shaped enclosure; a movable armature mounted above the electromagnet coil and equipped with arms; a cover plate superimposed over the enclosure, contemplating an aperture for actuation with a solidarity push-button with the movable armature, comprising two arms oscillatory hinged in a end of the base and having at the other end a protruding part for fitting connection with a respective stopper, positioned on the upper edge of the box-shaped enclosure, and below the cover plate. The protruding part is equipped with a threaded hole for fastening the respective screw, which passes through the cover plate to block the entire set to the base.

Document EP2462609 refers to a mechanical switching device of the second main concept cited above, comprising a base member, a system of main movable and fixed conductor members assembled on the base, an intermediate member assembled on the base member, a switching member adapted to establish and interrupt an electrical connection between the conductor ends of the pair of conductor members. The device comprises a stationary part and a movable part comprising a movable armature arranged on the upper part of the switching device.

In the second assembly concept the documents cited above have in common the main or power conductors assembled on the base or on the lower part of the device, whereby the electromagnetic actuator comprising coil, fixed and movable armature, remains above them. This construction facilitates replacing the main conductor members, however, none of the state-of-the-art documents comprises the inclusion of the auxiliary electrical conductor members and coil command conductors above the power electrical conductor members, concomitantly incorporated into the second assembly concept.

In the case of the first concept of intermediate split enclosures of the state of the art, the solutions favored the access to the coil in detriment of the main, auxiliary and coil command electrical conductors, while the solution which presents coil, movable and fixed armature on the upper part favored the access to the main conductors on the base, favoring access to the main or power conductor terminals, which can be manipulated, in a facilitated manner, as observed in the current technique.

In the case of the second state of the art concept the use of split movable carrier and the coil on the upper part allowed facilitating the quick replacement of the coil and of the main electrical conductors, failing, however, to present a solution contemplating auxiliary electrical and coil command controls, incorporated.

There currently exists, therefore, an unsolved possibility of a solution which can allow the replacement and the facilitated access, concomitantly of the coil and the main electrical conductors, in a simplified and efficient manner, which includes in the conception thereof auxiliary and command conductors, as well as persisting the need to simplify the insulation between the main conductor chambers and the auxiliary conductor chambers, so as to guarantee electrical insulation and increase the lifespan of these components.

Thus, it can be observed that a solution of this nature, allowing the facilitated assembly and access of main terminals close to the base of the device concomitantly with the coil, and on the other side, movable and fixed armature, auxiliary and coil command conductors arranged on the upper part of the main conductors of the switching device, having facilitated assembly, remains unsolved in the current technique.

### OBJECTS OF THE INVENTION

An object of the present invention is to solve the problems found in the state of the art, in as much as it proposes a switching device which allows easy assembly, replacement, and access to the components of the coil and main electrical conductors.

Another object of the invention is to eliminate the use of intermediate internal split enclosures for electrical conductors, jointly with the gaps in assembly that are intrinsic to this configuration.

Another object of the present invention is to disclose a switching device, comprised of main conductors fixed to the base, having the coil, the movable and fixed core positioned above the main power conductors, eliminating a pressure or spring connection between the power command of the coil and the connection terminal of the coil.

Another object of the invention is that in this configuration, contemplating the coil and the fixed and movable core arranged above the main conductors, there are also included auxiliary and coil command conductors.

Another object of the present invention is to provide a switching device with the possibility of connection of frontal accessories, such as, for example, in auxiliary conductor blocks, surge suppressor modules, or a dummy block, timers, among others, in replacement thereof, with housing incorporated into the enclosures on the upper part, close to the auxiliary conductors.

Another object of the present invention is that the assembly of base, movable carrier, coil, fixed armature, movable armature, and cover, can be arranged in a single assembly direction.

An additional object of the present invention is to provide a device wherein the auxiliary conductor chambers and the main conductor chambers are spaced from each other, having between them an intermediate enclosure which stores coil, movable core and fixed core, which serve as electrically insulating barrier between the main and auxiliary terminals.

This functional arrangement and advantages of the present invention will become more evident with the help of the drawings, which will serve to illustrate constructive details.

### BRIEF DESCRIPTION OF DRAWINGS

FIG. 1 illustrates a top perspective view of an electromagnetic switching device, object of the present invention.

FIG. 2 illustrates an exploded superior perspective view of the main components of the switching device of the present invention.

FIG. 3 illustrates a superior perspective view of a split movable carrier of the present invention.

FIG. 4 illustrates a longitudinal cross-sectional view of the switching device, object of the present invention, in the “OFF” position, comprising main and auxiliary conductor sets open between them and with magnetic cores completely separated.

FIG. 5 illustrates a longitudinal cross-sectional view of the switching device, object of the present invention, in the “intermediate” position, with the main and auxiliary conductor sets closed, but with the cores still separated on approach route.

FIG. 6 illustrates a longitudinal cross-sectional view of the switching device, object of the present invention in the “on” position, with the main and auxiliary conductor sets closed, and with the magnetic cores touching each other.

FIG. 7 illustrates a superior exploded perspective view of the switching device, object of the present invention, contemplating, in addition to other components, a support for auxiliary fixed elongated conductor members, assembled on the split movable carrier to a stationary intermediate set.

FIG. 8 illustrates a detailed superior perspective view of the switching device, object of the present invention, without the upper cover and presenting internally the support for auxiliary fixed elongated conductor members, assembled on the stationary intermediate set, indications “F”, “G” and a Detail “B”.

FIG. 9 illustrates a top perspective enlarged view of the Detail “B” of the present invention, highlighting a protective sliding latch of a movable carrier on the support of the auxiliary fixed elongated conductor members.

FIG. 10 presents a superior perspective view of a lower set of the switching device of the present invention.

FIG. 11 presents in superior side perspective a view of enlarged indication “G” (view in FIG. 8), of the fitting region of the support for auxiliary fixed elongated conductor members in the stationary intermediate set of the present invention.

### DETAILED DESCRIPTION OF THE DRAWINGS

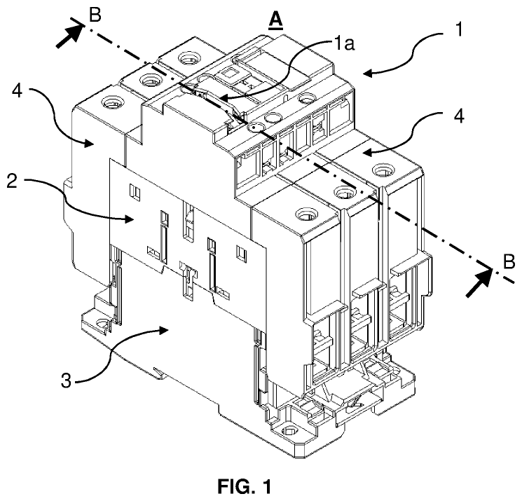

FIG. 1 illustrates in superior perspective an electromagnetic switching device (A), object of the present invention, comprising an upper cover (1) which comprises a slot (1a), a stationary intermediate set (2), a lower set (3), at least one connection set (4) and the indication of a section B-B.

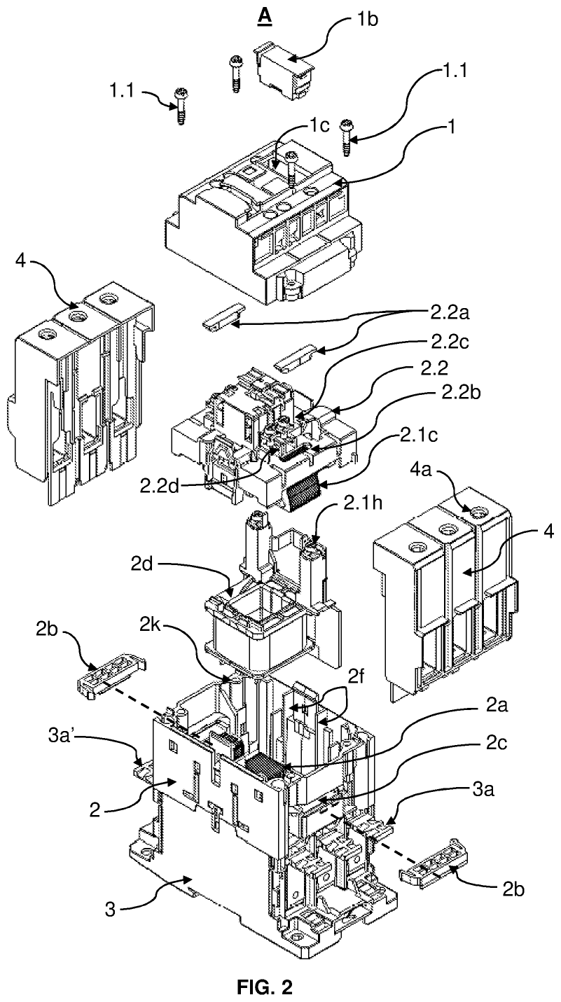

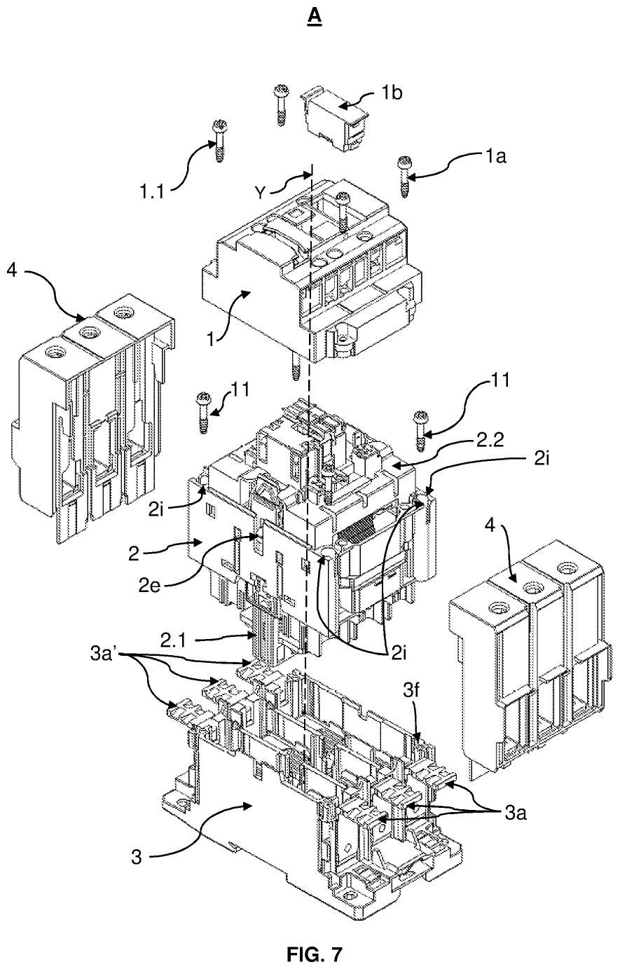

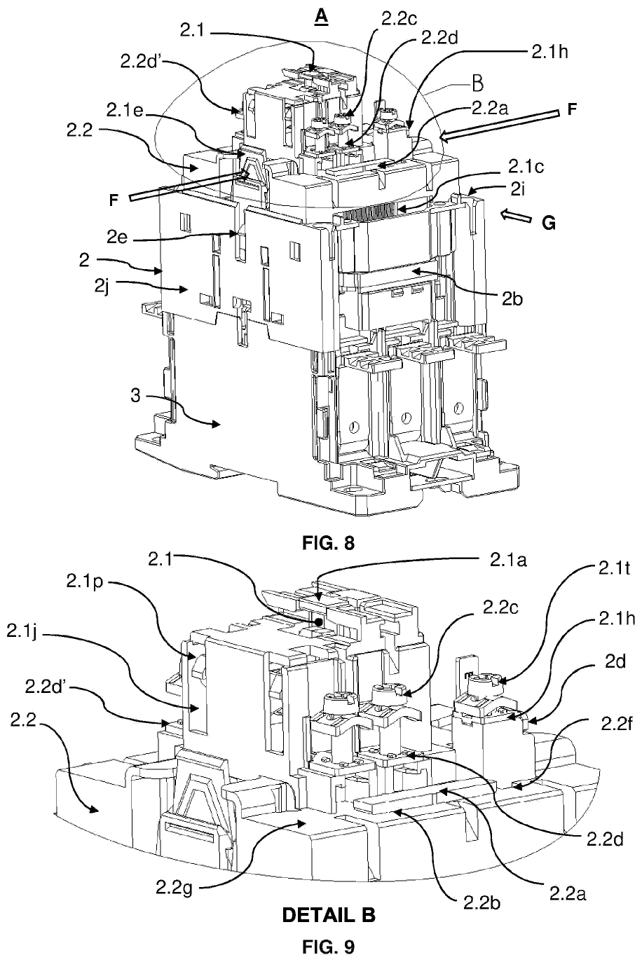

FIG. 2 illustrates the switching device (A), object of the present invention, in exploded superior view, which comprises an upper cover (1) comprising a cavity (1c) for housing a block (1b), fastening elements (1.1), a stationary intermediate set (2) comprising a fixed core (2a), aperture (2c) for mounting the latches (2b), for fastening the fixed core (2a), sliding vertical guides (2f) and cavities (2k) (best observed in FIG. 11), support for auxiliary fixed elongated conductor members (2.2), comprising stoppers (2.2a), holes (2.2b), fastening elements (2.2c) and auxiliary fixed elongated conductor members (2.2d, 2.2d′) (best observed in FIGS. 8 and 9), movable core (2.1c), coil (2d) comprising coil connection terminals (2.1h). Additionally, it comprises connection sets (4) comprising supply fasteners (4a) for the main fixed elongated conductor members (3a, 3a′). The stationary intermediate set (2) is shown fixed to the lower set (3) by fastener elements (11) (best observed in FIG. 7).

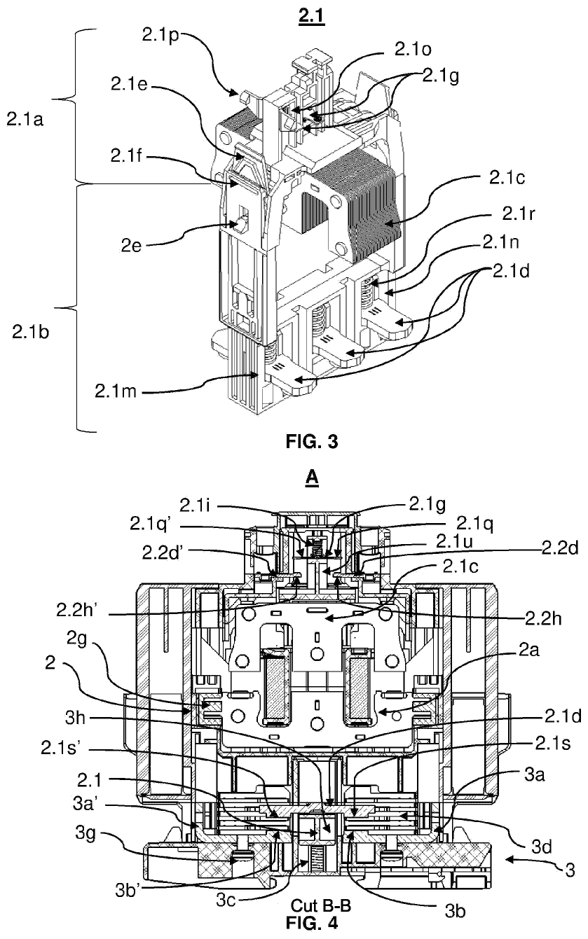

FIG. 3 illustrates a split movable carrier (2.1) of the switching device (A), object of the present invention in superior perspective view, comprising an upper portion (2.1a) and a lower portion (2.1b) wherein the upper portion (2.1a) comprises a sliding protective latch (2.1p), at least one housing chamber (2.10) for an auxiliary movable conductor bridge (2.1g), comprising conductor ends (2.1q) and auxiliary springs (2.1i) (seen in FIG. 4), a movable core (2.1c) or armature and a tab (2.1e); wherein the lower portion (2.1b) comprises at least one latch (2.1f), a coupling element (2e), at least one main movable conductor bridge (2.1d) and at least one main spring (2.1r) allocated in a chamber (2.1n), apart from sliding guide faces (2.1m); wherein the fastening between the upper portion (2.1a) and the lower portion (2.1b) of the split movable carrier (2.1) is made by locking between the tab (2.1e) and the latch (2.1f).

FIG. 4 is presented in a longitudinal cross-sectional view of the switching device (A), object of the present invention, in a configuration of main conductor set (2.1d; 3a, 3a′) formed by the main movable bridge (2.1d) and a pair of main fixed elongated conductor members (3a, 3a′) and an auxiliary conductor set (2.2d, 2.2d′; 2.1g) formed by an auxiliary movable bridge (2.1g) and by a pair of auxiliary fixed elongated conductor members (2.2d, 2.2d′), normally open (N. O.), in initial operating condition “OFF”. The switching device (A) comprises a lower set (3) comprising a pair of main fixed elongated conductor members (3a, 3a′), wherein each of the main fixed elongated conductor members (3a, 3a′) comprises a conductor end (3b, 3b′), fastening elements (3g) and a gap (3h) between the pair of main fixed elongated conductor members (3a, 3a′), positioned at each power end of the switching device (A). The switching device (A) further comprises return springs (3c) and arc extinguishing elements (3d), the split movable carrier (2.1), which comprises the main movable conductor bridge (2.1d), comprising a conductor end (2.1s, 2.1s′), wherein the operating position of the conductor ends (2.2h, 2.2h′) of the auxiliary fixed elongated conductor elements (2.2d) and the conductor ends (2.1g, 2.1g′) of the auxiliary movable conductor bridge (2.1g) have a spacing in the gap (2.1u) between each other. FIG. 4 further presents auxiliary springs (2.1i) and a movable core (2.1c) also known as movable armature. There can be additionally observed positioned inside the stationary intermediate set (2) a fixed core (2a) or fixed armature, supported on cushion bearings (2g), by means of fastening latches (2b) (seen in FIGS. 2 and 8), and main springs (2.1r) of the main movable bridge (2.1d) (seen in FIG. 3). In this position the split movable carrier (2.1) is positioned with the main conductor set (2.1d; 3a, 3a′) the auxiliary conductor set (2.2d, 2.2d′; 2.1g) open, wherein the movable core (2.1c) is separated from the fixed core (2a) positioned by the action of the return springs (3c).

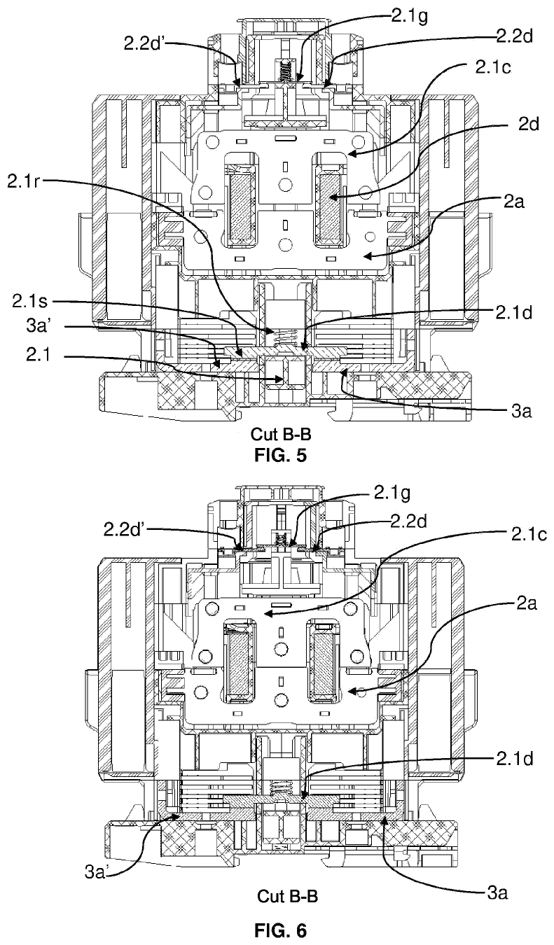

FIG. 5 presents a longitudinal cross-sectional view of the switching device (A), object of the present invention, in a configuration of the main conductor set (2.1d; 3a, 3a′) and of the auxiliary conductor set (2.2d, 2.2d′; 2.1g) normally open (N. O.), in “intermediate condition” of operation, in a magnetic attraction movement between the fixed core (2a) and the movable core (2.1c). The switching device (A) comprising the fixed core (2a) and the movable core (2.1c) activated by energizing the coil (2d), wherein the split movable carrier (2.1) is positioned with the main conductor set (2.1d; 3a, 3a′) and the auxiliary conductor set (2.2d, 2.2d′; 2.1g) closed, overcoming the spring action (3c) (seen in FIG. 4), but still on approach route to the movable core (2.1c) in relation to the fixed core (2a).

FIG. 6 presents a longitudinal cross-sectional view of the switching device (A), object of the invention, in final “ON” operating condition, in an embodiment of the main conductor set (2.1d; 3a, 3a′) and of the auxiliary conductor set (2.2d, 2.2d′; 2.1g) normally open (N. O.), wherein the movable core (2.1c) of the split movable carrier (2.1) (seen in FIG. 3) touches the fixed core (2a) of the stationary intermediate set (2). In this position, the main conductor set (3a, 3a′; 2.1d) and the auxiliary conductor set (2.2d, 2.2d′; 2.1g) are positioned closed, overcoming the action of the return springs (3c), of the main springs (2.1r) and of the auxiliary springs (2.1i) (seen in FIGS. 3 and 4), depending on the configuration of the auxiliary conductor set (2.1g; 2.2d, 2.2d′), particularly in this configuration of normally open conductor sets (N. O.). In another alternative configuration, the auxiliary conductor set (2.1g; 2.2d, 2.2d′) could be configured normally closed (N. C.) and in the “ON” position, the auxiliary conductor set (2.1g; 2.2d, 2.2d′) would be represented open (not represented).

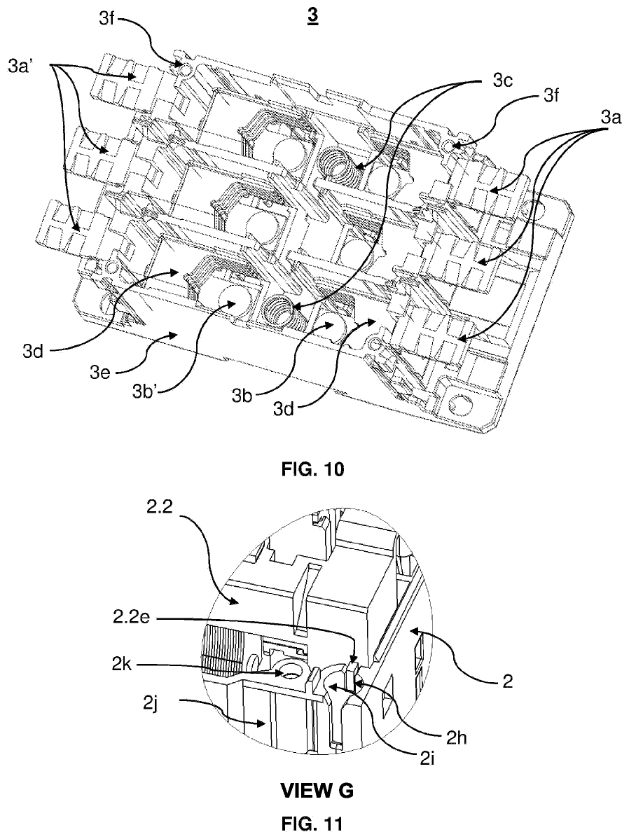

FIG. 7 illustrates the switching device (A), object of the invention, in exploded superior perspective, comprising the upper cover (1) and the fastening elements (1.1) for fastening of the upper cover (1) on the intermediate set (2) apart from a slot (1a) for passage of cables and the auxiliary block (1b), for example, a surge suppressor or an empty block (Dummy). The intermediate stationary set (2) comprises at least one cavity (2i) for passage of fastening elements (11), for fastening the stationary intermediate set (2) in a hole (3f) (seen in FIG. 10), of the lower set (3). The split movable carrier (2.1), comprising the coupling element (2e) for joint use with an auxiliary switching block on the side of the switching device (A) (not represented). The split movable carrier (2.1) being arranged on the interior part of the stationary intermediate set (2). Additionally, there are presented the connection set (4), a reference axis (Y) for assembly direction which extends longitudinally from the base of the switching device (A) to the upper part.

FIG. 8 presents in superior perspective the switching device (A), object of the present invention, with the connection set (4) and the upper cover (1) removed, comprising the support for auxiliary fixed elongated conductor members (2.2), comprising the fastening elements (2.2c) of the auxiliary fixed elongated conductors (2.2d, 2.2d′), assembled jointly with the split movable carrier (2.1), comprising the coupling element (2e). There is presented at least one the tab (2.1e) (also seen in FIG. 3) able to bend in transverse direction (F) to the reference direction axis (Y) (seen in FIG. 7), for uncoupling between the upper portion (2.1a) and the lower portion (2.1b) of the split movable carrier (2.1). The stationary intermediate set (2) comprises the intermediate enclosure (2j) and the lower set (3), wherein the intermediate enclosure (2j) is fixed by the fastening elements (11), by means of the at least one cavity (2i) (as seen in FIG. 7) in holes (3f) (seen in FIGS. 7 and 10). There are also presented the coil connection terminals (2.1h), the stopper (2.2a) (seen in FIGS. 2 and 9) of the movable core (2.1c) and the latches (2b) of the fixed core (2a) (as better seen in FIGS. 3 and 5). There is also presented an indication of Detail “G”, seen enlarged in FIG. 11.

FIG. 9 presents the switching device (A), object of the present invention, in enlarged superior perspective of the Detail B seen in FIG. 8 with the upper cover (1) removed, contemplating the stopper (2.2a), fitted in the hole (2.2b) of the contact faces (2.2g) of the auxiliary fixed elongated conductor members (2.2), comprising the fastening elements (2.2c) and housing the auxiliary fixed elongated conductor members (2.2d, 2.2d′) (also seen in FIG. 2). FIG. 9 further presents the upper portion (2.1a) of the split movable carrier (2.1), comprising a protective sliding latch (2.1p) internally fitted in a route limiting cavity (2.1j) of the split movable carrier (2.1) on the support for auxiliary fixed elongated conductor members (2.2) (also seen in FIG. 3). Another detail presented is that the coil connection terminals (2.1h) and the fastening elements (2.1t) of the coil (2d) (seen in FIG. 2), pass through the support for auxiliary fixed elongated conductor members (2.2) through a hole (2.2f), positioned above the stationary intermediate set (2) (seen in FIG. 8).

FIG. 10 presents a superior perspective view of the lower set (3) of the switching device (A), object of the present invention, comprising the lower enclosure (3e), the main fixed elongated conductor members (3a, 3a′) comprising the conductor end (3b, 3b′), the return springs (3c), holes (3f) and arc extinguishing elements (3d).

FIG. 11 represents an enlarged view of the Detail “G” (shown in FIG. 8) of the switching device (A), object of the present invention, comprising the support for auxiliary fixed elongated conductor members (2.2), comprising, at least one rib (2.2e) fitted into a slot (2h) located on the at least one cavity (2i) for passage of the intermediate enclosure (2j) of the stationary intermediate set (2) and the cavities (2k).

### Operation of the Invention

The present invention refers to a switching device (A), comprising at least one pair of main fixed elongated conductor members (3a, 3a′) arranged on a lower set (3), coil (2d), movable core (2.1c) and fixed core (2a), including an auxiliary conductor set (2.2d, 2.2d′; 2.1g) and coil connection terminals (2.1h) for commanding the coil (2d) positioned above the main power conductor set (3a, 3a′; 2.1d). In other words, the electromagnetic switching device (A), comprising the lower set (3) which houses at least one pair of the main fixed elongated conductor members (3a, 3a′), each of the main fixed elongated conductor members (3a, 3a′) comprising a conductor end (3b, 3b′), wherein the conductor ends (3b, 3b′) of the pair of main fixed elongated conductor members (3a, 3a′) are separated from each other by a gap (3h);
a stationary intermediate set (2) which comprises the fixed core (2a) and the coil (2d), arranged above the lower set (3), fixed by means of the fastening elements (11);
an upper cover (1) arranged above the stationary intermediate set (2), fixed by means of the fastening elements (1.1);
a split movable carrier (2.1), comprising the upper portion (2.1a) arranged above the fixed core (2a), which houses the movable core (2.1c) and the lower portion (2.1b), arranged below the fixed core (2a), which houses at least one the main movable conductor bridge (2.1d) comprising the conductor ends (2.1q, 2.1q′) and at least one the main spring (2.1r) arranged on at least one the chamber (2.1n), wherein the split movable carrier (2.1) slides on the sliding guides (2f) of the stationary intermediate set (2);
the upper portion (2.1a) housing at least one the auxiliary movable conductor bridge (2.1g), comprising the conductor ends (2.1q, 2.1q′) and the spring (2.1i) allocated in at least one the chamber (2.10);
wherein the auxiliary conductor set (2.1g; 2.2d, 2.2d′) is located at a separate position, above the main conductor set (3a, 3a′; 2.1d), in relation to axis “Y”.

The main conductor set (3a, 3a′; 2.1d) operates between a first “OFF” position and a second “ON” position, wherein in this the first position the conductor ends (3b, 3b′; 2.1s, 2.1s′) of the main conductor set (3a, 3a′; 2.1d) have a gap (3h) between them, and wherein in the second operating position, the main fixed elongated conductor members (3a, 3a′) are electrically connected by means of the conductor ends (3b, 3b′) in contact with the conductor ends (2.1s, 2.1s′) of the main movable conductor bridge (2.1d), positioned below the stationary intermediate set (2) and having an auxiliary movable conductor bridge (2.1g) above the stationary intermediate set (2).

As illustrated in the FIG. 4, in a preferred embodiment of the present invention, containing normally open conductors (N. O.) in initial condition in operating position “OFF”, the electromagnetic switching device (A) comprises an open the main conductor set (3a, 3a′; 2.1d).

In another preferred embodiment (not represented) of the present invention, the main conductor set (3a, 3a′; 2.1d) of the switching device (A) can be configured normally closed (N. C.). In this case, in an example, the conductor ends (2.1s, 2.1s′) of the main movable conductor bridge (2.1d), in Sleep mode “OFF” would make a mechanical and electrical connection with the conductor ends (3b, 3b′) of the main fixed elongated conductor members (3a, 3a′).

The switching device (A) (illustrated in FIG. 5), in an example of embodiment of the present invention, with the main conductor set (3a, 3a′; 2.1d), normally open (N. O.), as from the powering of the coil (2d), the split movable carrier (2.1) comprising the movable core (2.1c) moves toward the fixed core (2a), as from the magnetic attraction forces generated between the fixed core (2a) and the movable core (2.1c). In sequence, before the cores (2a; 2.1c) touch, there occurs first the electric connection touch of the main conductor set (2.1d; 3a, 3a′) and of the auxiliary conductor set (2.1g; 2.2d, 2.2d′) normally open (N. O.), almost simultaneously.

With the continuity of the movement, the attraction of the magnetic cores (2.1c; 2. a) commanded by the coil (2d), the pressure on the conductor ends (3b, 3b′; 2.1s, 2.1s′) increases until the movable core (2.1c) touches the fixed core (2a), overcoming the spring forces (2.1r; 2.1i; 3c) and finalizing the movement (illustrated in FIG. 6).

The switching device (A), object of the present invention, comprises the main conductor set (3a, 3a′; 2.1d), which makes the interconnection between the main fixed elongated conductor members (3a, 3a′) and at least one main movable conductor bridge (2.1d), by means of the conductor ends (3b, 3b′; 2.1s, 2.1s′). The main fixed elongated conductor members (3a, 3a′) are arranged on the lower set (3), while the main movable conductor bridge (2.1d) is arranged on the split movable carrier (2.1). This the switching device (A) comprises the incorporated auxiliary conductor set (2.1g; 2.2d, 2.2d′), which is formed by at least one pair of the auxiliary fixed elongated conductor members (2.2d, 2.2d′), allocated on the support for auxiliary fixed elongated conductor members (2.2) and by at least one auxiliary movable conductor bridge (2.1g), situated on the split movable carrier (2.1).

The lower set (3) is responsible for the fastening of the switching device (A) to an external component—example: panel, DIN rail by means of fasteners (not represented). The lower set (3) supports the main fixed elongated conductor members (3a, 3a′), preferably fixed by means of the fastening elements (3g). The lower set (3) lays the return springs (3c) of the split movable carrier (2.1) and the arc extinguishing elements (3d) for absorbing an arc normally formed during the opening between the main movable bridges (2.1d) and the main fixed elongated conductor members (3a, 3a′). The stationary intermediate set (2) provides a sliding of the split movable carrier (2.1) between an initial “OFF” position and an “ON” position, by means of the sliding guide faces (2.1m) and of the vertical sliding guides (2f), aligned with the reference axis (Y) of the switching device (A), supporting the coil (2d) and fastening the fixed core (2a) by means of the latches (2b), which are inserted in the apertures (2c) of the stationary intermediate set (2). The upper cover (1) provides insulation to the auxiliary incorporated conductor set (2.2d, 2.2d′; 2.1g) and supports the return impact of the split movable carrier (2.1), helped by the elastic stoppers (2.2a), during the cited operations of the switching device (A), driven by the return springs (3c) toward the upper cover (1). The elastic stoppers (2.2a) are positioned on the contact faces (2.2g) of the auxiliary fixed elongated conductor members (2.2.) and the upper cover (1).

In an alternative embodiment for this purpose of the auxiliary conductor sets (2.2d, 2.2d′; 2.1g) normally open (N. O.) (as seen in FIG. 4), the auxiliary movable bridge (2.1g) of the split movable carrier (2.1) operates alternatively between a “first and second” operating position as previously cited, wherein in the “first operating position” the conductor ends (2.2h, 2.2h′) of the pair of auxiliary fixed elongated conductor members (2.2d, 2.2d′), allocated on the support for fixed auxiliary elongated conductor members (2.2) comprise a spacing in the gap (2.1u) and in a “second operating position” the conductor ends (2.2h, 2.2h′) are mechanically and electrically connected to the auxiliary movable conductor bridge (2.1g) by means of the conductor ends (2.1q, 2.1q′).

In another embodiment (not represented), the auxiliary conductor set (2.2d, 2.2d′; 2.1g) of the switching device (A) can be configured normally closed (N. C.). In this case, in one example, the conductor end (2.1q, 2.1q′) of the auxiliary movable conductor bridge (2.1g), initially connects with the conductor end (2.2h, 2.2h′) of the auxiliary fixed elongated conductor members (2.2d, 2.2d′).

The configuration of the auxiliary conductor set (2.2d, 2.2d′; 2.1g), normally open (N. O.) or normally closed (N. C.), is defined in accordance with the desired application, being known to the state of the art and defined according to the specification of each application, and wherein variations in configuration are expected.

The connection set (4), used as example in this embodiment, provides an electric power connection access to the main fixed elongated conductor members (3a, 3a′) as from an external circuit (not represented), to be fixed by means of fastening elements (4a) of the connection set (4) in relation to the face of the main fixed elongated conductor members (3a, 3a′) in a versatile manner, allowing greater agility in the manufacturing and compaction process, when compared with the terminal connection systems incorporated in the state of the art. The connection set (4) could alternatively be constructed integrated with the lower and/or intermediate enclosures (2, 3), obtaining the same advantages of the inventive concept of the present invention.

A change of the coil (2d), for example, can be necessary in the application field, since apart from being possible to alter the power supply of the switching device (A) on the field, requiring the replacement thereof by another suitable to the power supply. Eventually, there can occur faults in this equipment throughout the lifespan thereof, due to several factors known to the art, which would make the functioning of the switching device (A) impossible, while other components remain intact and operate normally. In this manner, the replacement can be made solely of the coil (2d), avoiding making the entire switching device (A) useless. Moreover, there can occur the need for replacement of the main conductor set (2.1d; 3a, 3a′) on the field due to the mechanical working life of other components being usually much longer than the estimated electrical life in relation to the main conductor set (2.1d; 3a, 3a′). This does not prevent the replacement of other components of the switching device (A) during maintenance, which can benefit from the advantages obtained and justify the configuration of the present invention.

For both the need of replacement of the coil (2d) or of the main conductor (2.1d; 3a, 3a′) to be met in an efficient, alternative, or simultaneous manner, the assembly of the lower set (3), the stationary intermediate set (2), the split movable carrier (2.1) and the upper cover (1) were provided in the present invention with a single assembly direction among them.

In a first disassembly sequence of replacement maintenance of the coil (2d), after removal of the connection sets (4), fixed by pressure (seen in FIGS. 1, 2 and 7), the fastening elements (1.1) are loosened, and thus the removal of the cover (1) is possible, whereby the support for auxiliary fixed elongated conductor members (2.2) may be observed (as seen in FIG. 8).

The manner of fastening of the support for auxiliary fixed elongated conductor members (2.2) in the switching device (A) occurs in between the upper cover (1) and the intermediate enclosure (2j) of the stationary intermediate set (2), by means of fitting the rib (2.2e) of the support for auxiliary fixed elongated conductor members (2.2), fitted in the slot (2h) of the intermediate enclosure (2j), joined by the fastening elements (1.1) in the cavities (2k).

So as to have access to the coil (2d) for replacement, the removal of the fastening of the latch (2.1f) between the upper portion (2.1a) and the lower portion (2.1b) is made by bending the tab (2.1e) of the upper portion (2.1a) of the split movable carrier (2.1), promoting an opposing pressure movement in the direction (F) on each opposite side of the split movable carrier (2.1), allowing, after this process, to separate the upper portion (2.1a) of the split movable carrier (2.1), jointly with the movable core (2.1c) and the auxiliary fixed elongated conductor members (2.2), separating same from the lower portion (2.1b) of the split movable carrier (2.1) (as can be seen in FIGS. 2 and 3).

Once the upper portion (2.1a) is separated from the split movable carrier (2.1), the coil (2.1h), positioned in between the fixed core (2a), can be freely removed (as seen in FIG. 2).

In a second disassembly sequence for replacement maintenance of the main fixed conductor members (3a, 3a′), the main movable bridges (2.1d) and the return springs (3c), after removal of the connection sets (4) fixed by pressure (seen in FIGS. 1, 2 and 7), the fastening elements (11) are loosened in relation to the hole (3f) of the lower set (3) (similar to that seen in FIG. 7), except for the separation of the upper cover (1) of the intermediate set (2), which in this case remains assembled.

After removal of the stationary intermediate set (2), there is access to the interior of the lower set (3) (also seen in FIG. 10), comprising the main fixed elongated conductor members (3a, 3a′), fixed to the lower enclosure (3e) by fastening elements (3g), positioned on the lower face of switching device (A) (seen in FIG. 4), or, alternatively by clamps (not represented) and also to the main movable bridges (2.1d) of the split movable carrier (2.1).

A purpose reached by the present invention, was to solve the problems found in the state of the art, including incorporating in the same an enclosure for a switching device (A), apart from the main conductor set (3a, 3a′; 2.1d), also the auxiliary conductor set (2.1g; 2.2d, 2.2d′) eliminating the use of internal split enclosure for assembly of the conductor set. This purpose was reached with the creation of the support for auxiliary fixed elongated conductor members (2.2) including the auxiliary conductor set (2.1g; 2.2d, 2.2d′) on the upper part of the switching device (A) and separated in the lower set (3), the main conductor set (2.1d; 3a, 3a′), using the split movable carrier (2.1), comprising housed on the upper portion thereof (2.1a), at least one auxiliary movable conductor bridge (2.1b) and, in the lower portion (2.1b) thereof, at least one main movable conductor bridge (2.1d).

Another main purpose reached by the present invention for the switching device (A) is to allow easy assembly and disassembly, replacement and access to the components, both of the coil (2d), as of the main conductor set (2.1d; 3a, 3a′), having access to the coil (2d), and to the fixed core (2a) by the upper portion of the stationary intermediate set (2), while the main conductor set (3a, 3a′; 2.1d) has an access and fastening on the lower part of the lower set (3), with the concomitant inclusion of the auxiliary fixed elongated conductor members (2.1g; 2.2d, 2.2d′) and coil connection command terminals (2.1h) above the main power electrical conductor set (3a, 3a′; 2.1d) incorporated to the switching device (A). This purpose was reached by the present invention, providing the switching device (A) with the component assembly system, longitudinally aligned with the direction reference axis (Y) for the assembly process, which has its origin at the base of the lower set (3) and is aligned toward the front or upper part of the switching device (A). The present invention, by means of a combination of sequential overlay fittings allows, firstly by the removal of the fastening elements (1.1) and of the upper cover (1); subsequently by the disengagement of the tab (2.1e) from the latch (2.1f) of the upper portion (2.1a) of the split movable carrier (2.1) by bending in the direction (F) for uncoupling, executed without the use of tools and which releases the support for auxiliary fixed elongated conductor members (2.2) and the coil (2d); then, by the removal of the fastening elements (11) there is released the stationary intermediate set (2), comprising the fixed core (2a), the lower portion (2.1b) of the split movable carrier (2.1) which moves on the sliding guides (2f) in the direction between the lower set (3) and the upper cover (1), and thus there is direct access to the main fixed elongated conductor members (3a, 3a′) for eventual replacement and remaining components of the lower set (3). It is expected that these the fastening elements (1.1; 11) can alternatively be constructed by means of pressure clamps or similar (not represented). It must be observed that the sliding guides (2f) can be constructed in an alternative manner, optionally extending beyond the intermediate enclosure (2j) until the lower enclosure (3e).

With the positioning of the coil (2d) on the internal region of the stationary intermediate set (2) another purpose of the present invention was reached, eliminating a pressure or spring connection, existing between a coil power terminal of the switching device on the front or upper portion, and a coil terminal on the lower portion, present in the state of the art, in concepts wherein the coil is positioned on the lower portion of the device. With the positioning of the coil (2d) above the main fixed elongated conductor members (3a) it is possible to have direct access to the coil connection terminals (2.1h), without the need for a pressure or spring connection between the coil (2d) and the coil connection terminal (2.1h) on the upper part of the switching device (A), close to the auxiliary fixed elongated conductor members (2.2d, 2.2d′), due to not comprising the presence of main terminals between the coil (2d) and the coil command connection terminals (2.1h), as in the first main concept of the state of the art cited above. In this manner reliability problems during assembly are eliminated, by the elimination of an additional connection point (spring or pressure terminals, for example) between the coil and the coil connection terminals. The state of the art has already presented in another way, switching devices, containing main power terminals on the lower part of the devices, and using split movable carrier, however, they failed to provide a solution including the arrangement of auxiliary and coil command terminals on the upper part of the switching device, without additional connections or auxiliary blocks, known to the art. In the present invention, the coil connection terminal (2.1h) which connects directly to the winding of the coil (2d), passes through the auxiliary fixed elongated conductor members (2.2) by means of the hole (2.2f) so that the coil connection terminals (2.1h) are positioned above the stationary intermediate set (2) providing direct access to the user.

To allow the positioning of the main fixed elongated conductor members (3a, 3a′) on the lower set (3), the split movable carrier (2.1) provides a lower laying chamber (2. In) for at least one main movable conductor bridge (2.1d) and for the main springs (2.1r), positioned on the lower portion (2.1b) and aligned at operating level with the main fixed elongated conductor members (3a, 3a′) of the lower set (3). In the upper portion (2.1a) of the split movable carrier (2.1) the present invention provides an upper chamber (2.10) to accommodate the auxiliary conductor movable bridge (2.1g), together with the auxiliary springs (2.1i).

For the safe handling of the switching device (A) during the possible change of the coil (2d), the present invention provides the route limiting cavity (2.1j), which allows a guided sliding movement of the sliding protective latch (2.1p) of the split movable carrier (2.1) on the support for auxiliary fixed elongated conductor members (2.2), between a first and a second operating position, so as to protect the auxiliary conductor movable bridge (2.1g) from a bending movement, presented in the Detail B (seen in FIG. 9). This solution prevents the user from exceeding a height limit, that is, a height which reaches the compression limit of the auxiliary spring (2.1i) of the auxiliary movable conductor bridge (2.1g) during a maintenance or change of the coil (2d), guaranteeing safety in the handling of the components in the field, without the need for special tools.

With the positioning of the main fixed elongated conductor members (3a, 3a′) on the lower set (3) there is provided an added robustness to the lower set (3) of the switching device (A) when submitted to great efforts, such as in the occurrence of a short-circuit, for example, due to the one-piece format. Added to this, the support for auxiliary fixed elongated conductor members (2.2) according to the present invention is provided in one embodiment, without splitting in the construction thereof.

Another additional purpose achieved by the invention is to provide the switching device (A) with the possibility of including the connection of frontal accessories. This purpose was particularly reached in the upper or frontal part of the upper cover (1) which allows, for example, the use of auxiliary conductor blocks (not represented), surge suppressor modules (1b), groove (1a) for passage of cables or an empty block (not represented) in replacement thereof, timers, among others, with housing incorporated to the enclosure on the upper portion, near the auxiliary fixed elongated conductor members (2.2d, 2.2d′).

Obviously, it must be understood that other modifications and variations made to this invention are considered as being within the scope of the present invention.

1. An electromagnetic switching device, comprising:
a lower set that houses at least one pair of main fixed elongated conductor members, each of the main fixed elongated conductor members comprising a main fixed conductor end, wherein the main fixed conductor ends of the pair of main fixed elongated conductor members are separated from each other by a gap;
a stationary intermediate set that comprises a fixed core and coil arranged above the lower set;
an upper cover arranged above the stationary intermediate set; and
a split movable carrier, of the stationary intermediate set comprising an upper portion arranged above the fixed core, and a lower portion, arranged below the fixed core, which houses at least one main movable conductor bridge, comprising main movable conductor ends;
wherein the upper portion of the split movable carrier houses a movable core and at least one auxiliary movable conductor bridge, comprising auxiliary movable conductor ends.

2. The electromagnetic switching device according to claim 1, wherein the split movable carrier is configured to operate between a first and a second operating position;
wherein in the first operating position, the main fixed and main movable conductor ends are separated from each other by the gap, and;
wherein in the second operating position, the main fixed elongated conductor members are electrically connected by means of the main fixed conductor ends in contact with the main movable conductor ends of the main movable conductor bridge.

3. The electromagnetic switching device according to claim 1, wherein the fixed core of the stationary intermediate set by means of fastening latches.

4. The electromagnetic switching device according to claim 1, wherein the stationary intermediate set further comprises an auxiliary fixed support for one or more auxiliary fixed elongated conductor members; and
wherein stoppers are positioned in holes of contact faces between the auxiliary fixed support and the upper cover.

5. The electromagnetic switching device according to claim 4, wherein the auxiliary fixed support houses at least one pair of auxiliary fixed elongated conductor members.

6. The electromagnetic switching device according to claim 5, wherein the auxiliary fixed support comprises at least one route limiting cavity for a sliding protective latch of the upper portion of the split movable carrier, which allows a sliding guided movement between a first and a second operating position of the electromagnetic switching device.

7. The electromagnetic switching device according to claim 4, wherein the manner of fastening the auxiliary fixed support on the switching device occurs between the upper cover and an intermediate enclosure of the stationary intermediate set positioned by means of a rib in a slot.

8. The electromagnetic switching device according to claim 1, wherein the fastening between the upper portion and the lower portion of the split movable carrier is made by interlocking between a tab and a latch.

9. The electromagnetic switching device according to claim 8, wherein the removal of the fastening of the latch between the upper portion and the lower portion is made by bending of the tab of the upper portion of the split movable carrier.

10. The electromagnetic switching device according to claim 1 further comprising a connection set that provides an electric power connection access for the main fixed elongated conductor members, by means of fastening elements.

11. The electromagnetic switching device according to claim 4, the wherein coil connection terminals are connected directly to the winding of the coil and pass through the auxiliary fixed support positioned above the stationary intermediate set through holes.

12. The electromagnetic switching device according to claim 1, wherein the auxiliary conductor movable bridge of the movable split carrier operates alternatively between a first and a second operating position;
wherein the stationary intermediate set further comprises an auxiliary fixed support for one or more auxiliary fixed elongated conductor members;
wherein in the first operating position, auxiliary fixed conductor ends of a pair of the auxiliary fixed elongated conductor members each comprise a spacing in a gap; and
wherein in the second operating position, the auxiliary fixed conductor ends are connected to the auxiliary movable bridge by means of the auxiliary movable conductor ends.

13. The electromagnetic switching device according to claim 1, wherein the split movable carrier slides on sliding guides of the stationary intermediate set; and
wherein the lower portion comprises at least one lower laying chamber for the main movable conductor bridge and for main springs.

14. The electromagnetic switching device according to claim 1, wherein the upper cover comprises an electrical conductor passage groove configured to house a block in a cavity.
